(19) United States
(12) Patent Application Publication
(10) Pub. No.: US 2004/0166460 A1
(43) Pub. Date: Aug. 26, 2004

(54) Orthodontic anchor

(76) Inventor: John Devincenzo, San Luis Obispo, CA (US)

Correspondence Address: Walter A. Rodgers, 880 North Island Drive, Atlanta, GA, 30327, US

(21) Appl. No.: 10/374,358

(22) Filed: Feb. 25, 2003

(51) Int. Cl. A61C 3/00

(52) U.S. Cl. 433/18; 433/173

(57) ABSTRACT

An anchor for use in an orthodontic application having an outer portion and an inner portion joined together with multiple scallops extending from the junction thereof. A circular or angular cap envelops the outer portion with attachments secured to the cap. Angular wires are affixed to the cap to deliver a variety of forces with varying vectors. The cap is also utilized in connection with various implants including stemplants and miniscrews.

### BACKGROUND OF THE INVENTION

In the field of orthodontics, stemplants, miniscrews and many other means have been used as osseointegratable devices from which to anchor orthodontic forces and achieve desired movement of a patient's teeth. Historically, this movement is in a linear direction wherein teeth are pushed in one direction or pulled in the opposite direction by means of force application at a point distant from the anchoring device. Heretofore it has been impossible to achieve desired rotation or torquing of the teeth. This is because known anchors comprise single posts or rings which do not provide the required biasing forces to achieve desired tooth rotation or torquing. Additionally the point of force application is from the anchor often resulting in undesirable vectors, moments and torquing.

### BRIEF SUMMARY OF THE INVENTION

An orthodontic anchor comprising an outer portion and an inner portion joined together, and a cap positioned over the outer portion with multiple attachments selectively affixed to the cap.

### BRIEF DESCRIPTION OF THE SEVERAL VIEWS OF THE DRAWING

In the drawings,

FIG. 1 is a perspective view of an orthodontic anchor according to one embodiment of this invention;

FIG. 2 is an elevational view of a modified form of the anchor shown in FIG. 1 in which a cap is fitted over the anchor and a tube is attached to the cap;

FIG. 3 is a side elevational view of the anchor, cap and tube shown in FIG. 2;

FIG. 4 is an enlarged perspective view of the outer portion of the anchor shown in FIG. 2;

FIG. 5 is an elevational view depicting the application of force remotely from the anchoring means and shows a different vector of force than would be obtained if the force application was directly from the implant;

FIG. 6 is a perspective view showing the application of force remotely;

FIG. 7 is an elevational view of a modified form of the anchor;

FIG. 8 is an elevational view of a modification of the anchor with a staple-type lower portion;

FIG. 9 shows an application of the anchor shown in FIG. 1 with contoured and scallops and including a bone penetrating lower portion;

FIG. 10 is an elevational view of a further modification of the anchor; and

FIG. 11 is a view similar to FIG. 8 with an extended screw length.

### DETAILED DESCRIPTION OF THE INVENTION

In the drawings and with particular reference to FIG. 1, the numeral 1 generally designates an orthodontic anchor according to this invention. Anchor 1 comprises outer portion 2 which is generally angularly-shaped in cross-section but may be elliptical, round or a combination of shapes. Inner portion 3 is shown as being threaded in FIG. 1, as is well known. Inner portion 3 could also be configured as shown in FIG. 8 whereby it is pounded into the patient's bone. In addition, indented ring 4 is formed in outer portion 2 and sphere 5 is secured to the top of outer portion 2, also as well known. To complete the basic elements of anchor 1, multiple scallops 6 can extend outwardly from the junction between outer portion 2 and inner portion 3.

Scallops 6 are thin and malleable so that they can be manipulated to conform to the varying contours of the surface of the bone such that osseointegration can occur as depicted in FIG. 9. As a further improvement, apertures 7 are drilled in certain of scallops 6 into which a biocompatible glue material may be placed to help stabilize the stemplant during the process of osseointegration. Also small screws are insertable in apertures 7 for stabilization. In an alternative application of this invention and as shown in FIG. 10, inner portion 3 is eliminated and glue is placed in apertures 7 or small biocompatible screws are inserted through apertures 7 to facilitate anchor stability until osseointegration occurs.

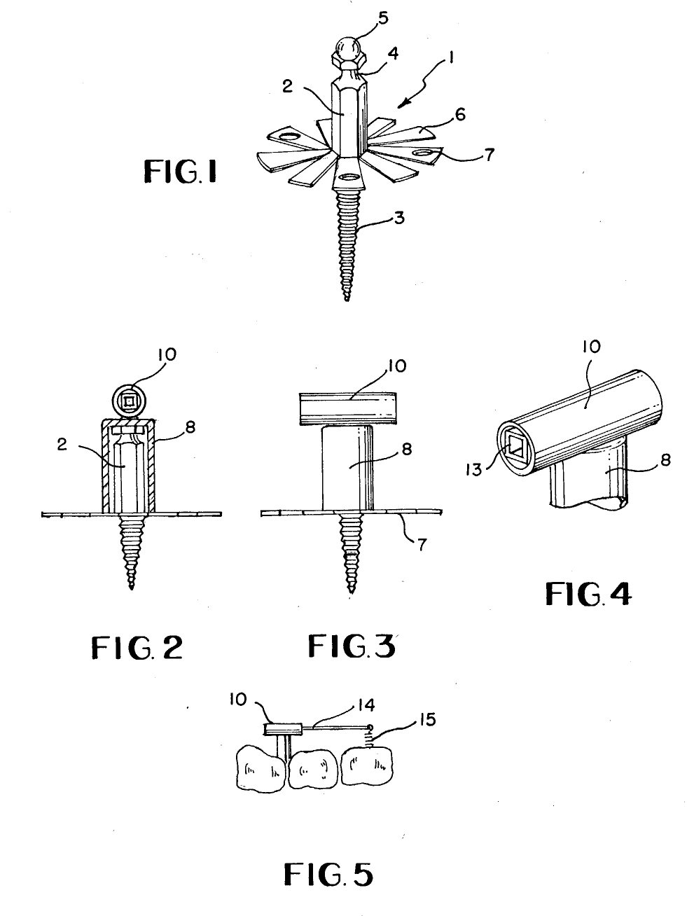

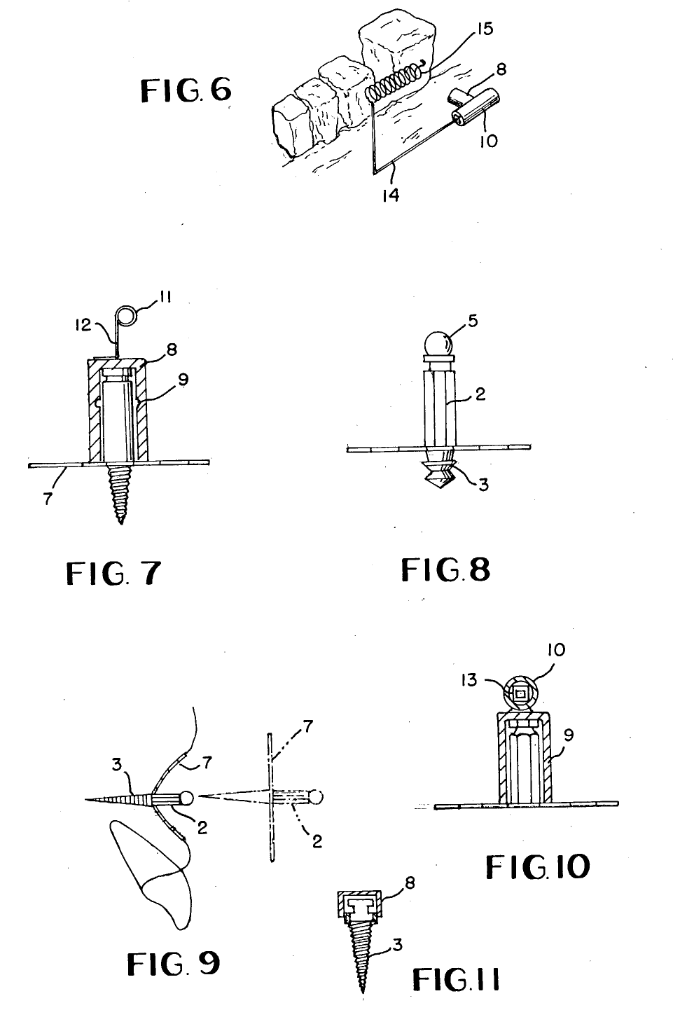

According to this invention and as depicted in FIGS.2, 3 and 4, cap 8 is positioned over and secured to outer portion 2. The interior surface of cap 8 is angular or circular in shape to conform to the shape of outer portion 2, as shown in FIG. 2. Horizontal and/or vertical grooves can be formed on the interior surface of cap 8 in order to enhance the retention of cap 8 on outer portion 2. An example is shown in FIGS. 7 and 10 in the form of Horizontal groove 9.

Of course, for purposes of this invention, any multi-lateral or circular configuration of outer portion 2 is acceptable, the only requirement being that the interior surface of cap 8 be configured so as to provide adequate retention means so that cap 8 is not allowed to rotate on outer portion 2. A cementing medium is typically used to firmly secure cap 8 to outer portion 2.

A round or quadrilateral tube 10 may be attached to the top or side of cap 8. Several different types of devices are inserted through tube 10 such as wires, springs, elastics and other means to deliver force in varying directions. A modification of tube 10 is shown in FIG. 7 wherein tube 11 is attached to the top of cap 8 by means of angular extension 12. Of course, a round or quadrilateral wire may be attached directly to cap 8 without the utilization of a tube.

For the purpose of receiving a quadrilateral wire, quadrilateral sleeve 13 is positioned in and secured to the inner surface of tube 10. In practice, wire 14 is inserted into angular sleeve 13 and extends remotely to the position of force application, as shown in FIGS. 5 and 6. Since angular wire 14 is prevented from rotating, the clinician has the ability to provide a rotational force to the desired tooth by means of application appliance 15. By manipulating and extending the wire in any direction at the point of application, force in any direction can be applied to a single tooth or multiple teeth, either linear or rotational. Also, quadrilateral sleeve 13 or, alternatively, quadrilateral wire 14 is attachable directly to the top surface of cap 8.

It is well known for inner portion 3 to be threaded, as shown in FIG. 1, such that the anchor is screwed into the bone. Threading may be difficult or at times impossible because scallops 6 prevent rotation of anchor 1 due to the proximity of adjacent bone, as shown in FIG. 9. A modification of this invention is shown in FIG. 8 wherein inner portion 3 is self-tapping such that anchor 1 is pounded into position and then scallops 6, which are thin and flexible, can be molded to the irregular bone contours, as shown in FIG. 9. By this means, anchor 1 is inserted into position without the inherent difficulties associated with a screw-type anchor.

Also, cap 8 is adaptable to other types of anchors, such as shown in FIG. 11. For example, the removal of scallops 6 still provides favorable force vector or torque tooth movement with cap 8 in place.

Therefore, by this invention, an anchor is provided by which the point of force application can be at some distance from the anchor while providing linear as well as rotational movement to a tooth or teeth.

1. An orthodontic anchor comprising an outer portion, multiple scallops extending outwardly from the bottom of said outer portion, and a cap enveloping said outer portion.

2. An anchor according to claim 1 wherein a tube is secured to said cap.

3. An anchor according to claim 2 wherein an angular sleeve is secured to the inner surface of said tube.

4. An anchor according to claim 1 wherein said outer portion is multilateral.

5. An anchor according to claim 4 wherein the inner surface of said cap is multilateral to conform to the configuration of said outer portion.

6. An anchor according to claim 3 wherein said sleeve is quadrilateral in configuration.

7. An anchor according to claim 1 wherein an aperture is formed in at least one of said scallops for receiving biocompatible glue material.

8. An anchor according to claim 1 wherein an inner portion is joined to said bottom.

9. An anchor according to claim 8 wherein said inner portion is self-tapping.

10. An anchor according to claim 1 wherein the inner surface of said cap comprises vertical grooves.

11. An anchor according to claim 1 wherein the inner surface of said cap comprises horizontal grooves.

12. An anchor according to claim 1 wherein a circular groove is formed in the surface of said outer portion.

13. An orthodontic anchor comprising an outer portion, an inner portion secured to said outer portion, and a cap enveloping said outer portion.

14. An anchor according to claim 13 wherein the inner surface of said cap is of an angular configuration and wherein at least one groove is formed in the inner surface of said cap.

15. An anchor according to claim 13 wherein an attachment is secured to said cap to facilitate delivery of force remotely from said anchor.

16. An anchor according to claim 15 wherein said attachment delivers rotational, torquing and translational forces remotely from said anchor.

17. An anchor according to claim 13 wherein multiple scallops extend outwardly from the junction between said outer and inner portions.

18. An anchor according to claim 17 wherein apertures are selectively formed in said scallops for the purpose of securing said anchor to bone by means of small screws.

19. An anchor according to claim 13 wherein said cap is secured to said outer portion by means of a cementing agent.

20. An orthodontic anchor comprising an outer portion, at least one scallop extending outwardly from the bottom of said outer portion, an aperture formed in said scallop, and biocompatible glue material disposed in said aperture.
